(19) United States
(12) Patent Application Publication
(10) Pub. No.: US 2007/0004251 A1
(43) Pub. Date: Jan. 4, 2007

(54) Post top connector and modular architectural garden assembly comprising same

(75) Inventor: Ronald McCarthy, Toronto (CA)

Correspondence Address: BERESKIN AND PARR, 40 KING STREET WEST, BOX 401, TORONTO, ON, M5H 3Y2, CA

(73) Assignee: Borrowed Spaces, Inc., Toronto, CA (US)

(21) Appl. No.: 11/171,241

(22) Filed: Jul. 1, 2005

(51) Int. Cl. H01R 12/00

(52) U.S. Cl. 439/82

(57) ABSTRACT

A post top beam connector for connecting beams to a post for a modular garden structure comprising a post-receiving member for receiving the post wherein the post receiving member comprises an open end for receiving the post, an elongate interior wall for surrounding a potion of the post inserted into the post receiving member, and a closed end for impeding further insertion of the post into the post-receiving member, wherein the elongate interior wall is dimensioned to impede substantial lateral movement of the post within the post-receiving member; and, a beam-securing member for securing a plurality of beams, the beam-securing member being coupled to the post-receiving member; wherein the closed end of the post-receiving member is operable to support the post-receiving member and the beam-securing member at a top of the post when a longitudinal axis of the post is vertically oriented.

### FIELD OF THE INVENTION

The present invention relates to a modular architectural garden assembly and to a post top connector included in the modular architectural garden assembly.

### BACKGROUND OF THE INVENTION

Modular architectural systems can be assembled in different ways to provide enclosed areas for privacy, create special areas of interest and define spaces in and around the garden. Typically, modular architectural garden assemblies will be made up of standard components such as panels, posts and beams. These standard components can then be assembled to provide different garden arrangements.

### SUMMARY OF THE INVENTION

In accordance with one aspect of the present invention there is provided a connector for connecting a plurality of beams to a post, the connector comprising a post-receiving member for receiving the post, wherein the post-receiving member comprises an open end for receiving the post, an elongate interior wall for surrounding a portion of the post inserted into the post-receiving member, and a closed end for impeding further insertion of the post into the post-receiving member, wherein the elongate interior wall is dimensioned to impede substantial lateral movement of the post within the post-receiving member and, a beam-securing member for securing a plurality of beams, the beam-securing member being coupled to the post-receiving member, wherein the closed end of the post-receiving member is operable to support the post-receiving member and the beam-securing member at a top of the post when a longitudinal axis of the post is vertically oriented.

In accordance with a second aspect of the present invention there is provided a modular architectural garden assembly. The modular architectural garden assembly comprises a plurality of posts, a plurality of beams, and a plurality of connectors for connecting the beams to the posts. Each connector in the plurality of connectors includes a post-receiving member for receiving the post, a closed end for impeding further insertion of the post into the post-receiving member and a beam-securing member for securing beams, the beam-securing member being coupled to the post-receiving member. The post-receiving member has an open end for receiving the post and an elongate interior wall for surrounding a portion of the post inserted into the post-receiving member. The elongate interior wall is dimensioned to impede substantial lateral movement of the post within the post-receiving member.

### BRIEF DESCRIPTION OF THE DRAWINGS

A detailed description of the preferred embodiments is provided herein below with reference to the following drawings, in which:

FIG. 1, in a side view, illustrates a connector for connecting a plurality of beams to a post in accordance with a first preferred embodiment of the present invention;

FIG. 2, in a top view, illustrates the connector of FIG. 1;

FIG. 3, in a side sectional view taken along line A-A of FIG. 2, illustrates the connector of FIG. 1;

FIG. 4, in a perspective view, illustrates a connector for connecting a plurality of beams to a post in accordance with a second preferred embodiment of the present invention;

FIG. 5, in a perspective view, illustrates the connector of FIG. 4 with pivotable flanges pivoted to a different orientation than the orientation shown in FIG. 4;

FIG. 6, in an exploded perspective view, illustrates a modular architectural garden assembly in accordance with a further preferred embodiment of the present invention;

FIG. 7, in a plan view, illustrates a plate that can be used to make a post-receiving member of the connector of FIG. 1;

FIG. 8, in a plan view, illustrates a modified plate obtained from the plate of FIG. 7;

FIG. 9, in a perspective view, illustrates the post-receiving member of the connector of FIG. 1 obtained from the modified plate of FIG. 8;

FIG. 10, in a plan view, illustrates two pairs of plates that can be used to make a beam-receiving member of the connector of FIG. 1;

FIG. 11, in a perspective view, illustrates the two pairs of plates of FIG. 10 aligned to be mated together to form the beam-securing member of the connector of FIG. 1; and,

FIG. 12, in a perspective view, illustrates the connector of FIG. 1 obtained by assembling the beam-securing member provided by the two pairs of plates of FIGS. 10 and 11, and the post-receiving member of FIG. 9.

### DETAILED DESCRIPTION OF THE INVENTION

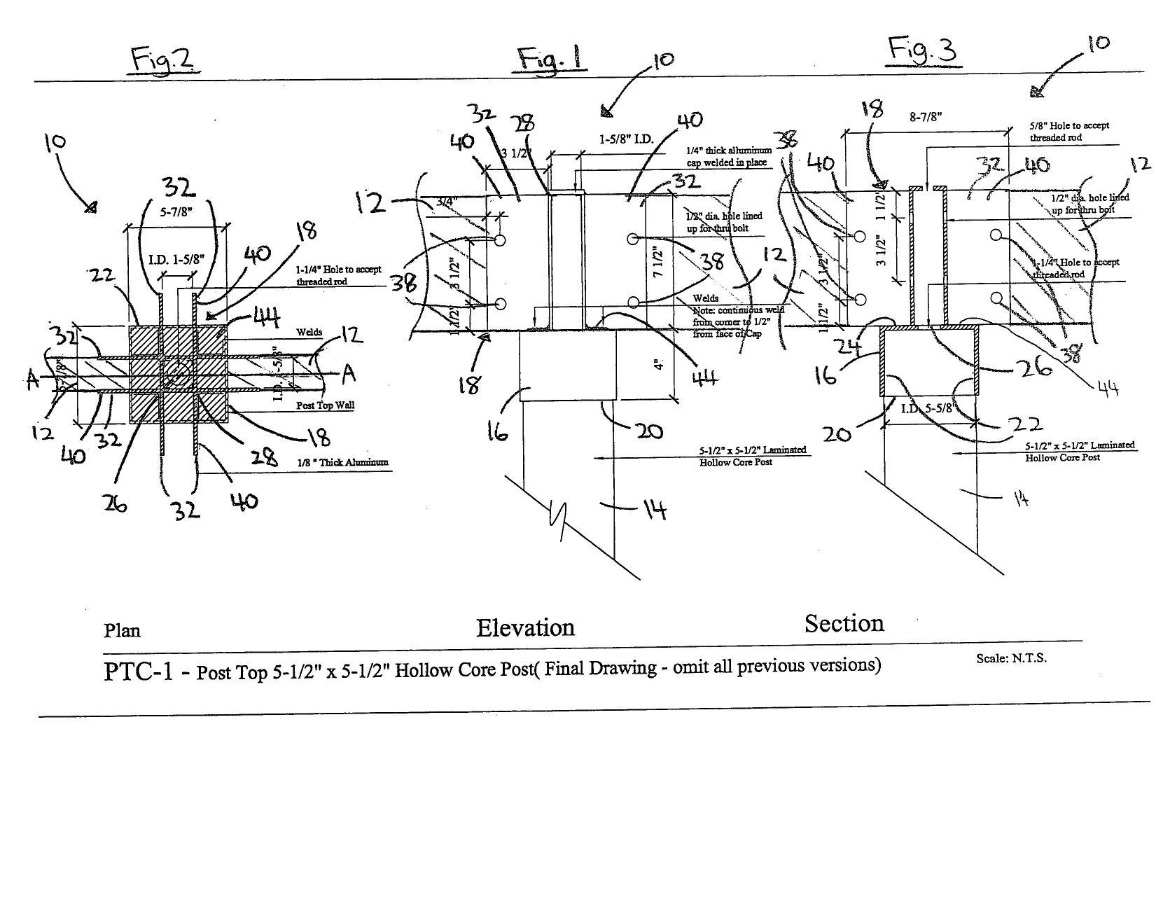

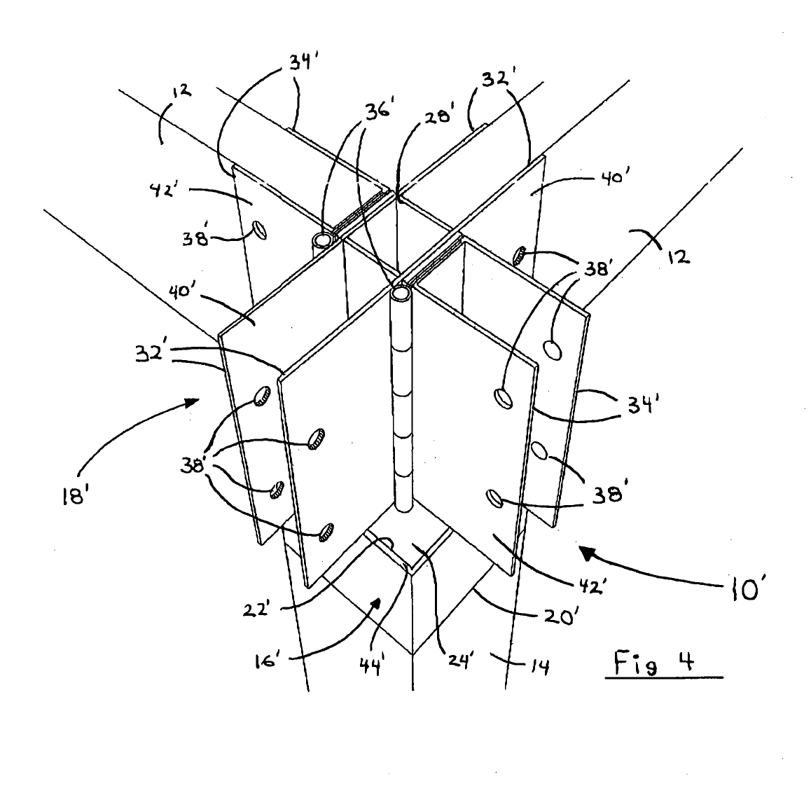

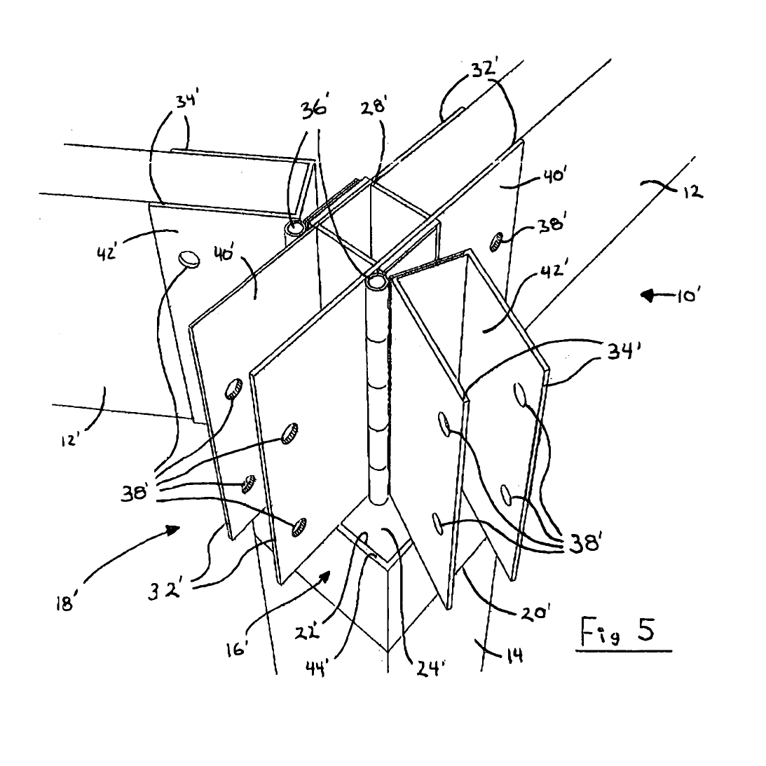

Referring to FIGS. 1 to 3, there is illustrated a connector 10 for connecting a plurality of beams 12 to a post 14 in accordance with a first preferred embodiment of the invention. The connector 10 includes a post-receiving member 16 and a beam-securing member 18. The post-receiving member 16 comprises an open end 20 for receiving the post 14, an elongate interior wall 22 (shown best in FIG. 3) for surrounding a portion of the post 14 inserted into the post-receiving member 16, and a closed end 24 for impeding further insertion of the post 14 into the post-receiving member 16. That is, when vertically oriented, as shown for example in FIG. 3, the upper end of the post 14 supports closed end 24, thereby supporting post-receiving member 16.

The elongate interior wall 22 is preferably dimensioned to impede substantial lateral movement of the post 14 within the post-receiving member 16. In different embodiments, the elongate interior wall 22 may be dimensioned to provide a snug fit around post 14 to impede substantial lateral movement of the post 14 within the post-receiving member 16. As shown in FIG. 3, closed end 24 optionally may have one or more apertures 26 to receive fasteners such as bolts for securing the closed end 24 of the post-receiving member 16 to the top of the post 14. The aperture 26 is preferably positioned within rigid support member 28 so that it is hidden from view for better appearance as illustrated in FIG. 3. The closed end 24 of the post-receiving member 16 preferably consists of a plate covering the closed end 24 or in other embodiments, such as those shown in FIGS. 4 and 5, the closed end may consist of rigid support member 28, rigid flanges 32 and/or pivotable flanges 34 for impeding further insertion of post 14 into the post-receiving member 16.

Referring back to FIGS. 1 to 3, the post-receiving member 16 has an elongate interior wall 22 preferably having a square cross-section for receiving a post with a corresponding square cross-section. However, the post-receiving member 16 may be configured to receive posts with cross-sections of different shapes, for example, rectangular or circular shapes.

The beam-securing member 18 is attached to post-receiving member 16 by attaching rigid support member 28 of beam-securing member 18 to the closed end 24 of post-receiving member 16. Preferably, the rigid support member 28 is welded to closed end 24 of post-receiving member 16.

The beam-securing member 18 comprises a plurality of flanges 32 for securing a plurality of beams. Flanges 32 may be secured to the post-receiving member 16 by welding flanges 32 to closed end 24 of the post-receiving member 16.

In preferred embodiments of the present invention shown in FIGS. 1 to 3, beam-securing member 18 comprises a rigid support member 28 with a hollow square cross-section. Flanges 32 extend from each face of the rigid support member 28. Rigid support member 28 may optionally have differently shaped cross-sections. 32. For example, rigid support member 28 may have a triangular cross-section. In this case, rigid support member 28 could be configured to provide three faces from which flanges could extend to enable beams to project in three different directions from the central post. Of course, not all faces of rigid support member 28 are required to have flanges.

Beams 12 may be attached to the outside of each flange 32 such that each flange 32 supports its own beam 12. Alternatively, beam 12 may be inserted between parallel flanges such that beam 12 is supported by two flanges 32. Each flange 32 preferably has two or more apertures 38 for receiving fasteners, for example bolts, for securing the beam.

In one embodiment of the present invention, one flange extends from each face of rigid support member 28. Each flange may be attached to one side of a beam and secured by fasteners such as bolts. Alternatively, the flange may be fitted into a precut groove of a beam and secured by fasteners such as bolts. In the preferred embodiment shown in FIGS. 1 to 3, U-shaped brackets 40 extend from each face of rigid support member 28 to provide two parallel flanges 32 for securing the beams 12. The beams 12 are attached to flanges 32 of the U-shaped brackets 40 by aligning the vertical faces of at least one side of the beam 12 flush against the flanges 32 and securing the beams 12 to the flanges 32 with fasteners such as bolts.

The post-receiving member 16 further comprises a flange-supporting surface 44 for supporting the plurality of flanges 32. The plurality of flanges 32 preferably extends away from the rigid support member 28 over the flange-supporting surface 44. In this fashion, most of the weight of the horizontal beams 12 is supported on the flange-supporting surface 44, thereby reducing the stresses acting on the flanges 32. Only a portion of the bottom surface of flanges 32 need be supported by the flange-supporting surface 44. Flanges 32 extend from the rigid support member 28 over and beyond the flange-supporting surface 44.

Referring to FIGS. 4 and 5, a second preferred embodiment of the present embodiment is illustrated. For clarity, the same reference numerals, together with an apostrophe, are used to designate elements analogous to elements of the embodiment of FIGS. 1 to 3 described above. For brevity, the description of the embodiment of FIGS. 1 to 3 is not repeated with respect to FIGS. 4 and 5. As shown, the connector 10′ comprises a beam-securing member 18′ with both rigid flanges 32′ and pivotable flanges 34′ attached to a rigid support member 28′ with a hollow square cross-section. In this second preferred embodiment, each U-shaped bracket 40′ includes two rigid flanges 32′, and each pivotable U-shaped bracket 42′ includes two pivotable flanges 34′ for securing the beams 12. Pivotable flanges 34′ of pivotable U-shaped brackets 42′ are pivotable about pivotable attachment or hinge 36′. The pivotable attachment 36 allows pivotable flanges 34′ to be rotated from a first orientation to a second orientation In FIG. 5, the pivotable flanges 34′ are pivoted away from the first orientation to the second orientation. The fact that the pivotable flanges 34′ can be pivoted relative the rigid flanges 32′ facilitates non-orthogonal beam connections.

Post-receiving member 16′ comprises an open end 20′ for receiving the post 14 with an elongate interior wall 22′ for surrounding a potion of the post 14 inserted into the post-receiving member 16′, and a closed end 24′ for impeding further insertion of the post 14 into the post-receiving member 16′. As described above, the closed end 24′ of the post-receiving member 16′ is closed by rigid support member 28′ and by U-shaped brackets 40′ and 42′. Rigid support member 28′ is fixed in place relative to post-receiving member 16′ by being attached to rigid flanges 32′, which are, in turn, attached to flange supporting surface 44′, which supports both the rigid flanges 32′ and the pivotable flanges 34′. Flange-supporting surface 44′ provides a smooth surface configured relative to the lower edge of the U-shaped bracket 42′ such that flange-supporting surface 44′ is constantly in contact with the U-shaped bracket 42′ during rotation, but does not at any point obstruct rotation of the U-shaped bracket 42′ from the first orientation shown in FIG. 4 to the second orientation shown in FIG. 5.

As described above in connection with the embodiments of FIGS. 1 to 3, the elongate interior wall 22′ is preferably dimensioned to impede substantial lateral movement of the post 14 within the post-receiving member 16′. Closed end 24′ optionally may have one or more apertures 26′ to receive fasteners such as bolts for securing the closed end 24′ of the post-receiving member 16′ to the top of the post 14. The aperture 26′ is preferably positioned within rigid support member 28′ so that it is hidden from view for better appearance.

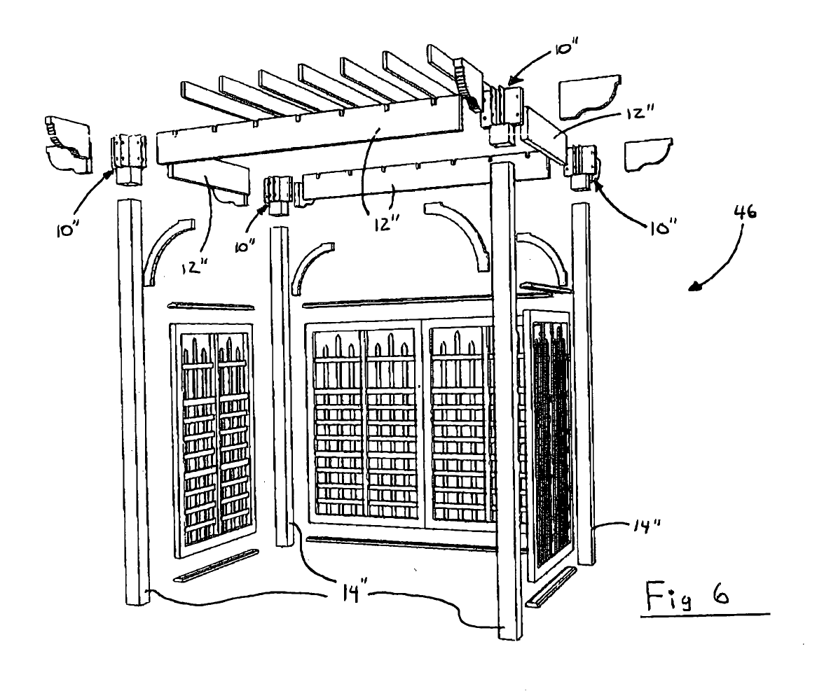

Referring to FIG. 6, a modular architectural garden assembly in accordance with a third aspect of the invention is illustrated. For clarity, the same reference numerals, together with a double apostrophe, are used to designate elements analogous elements described above in connection with FIGS. 1 to 5. For brevity, the description of FIGS. 1 to 5 is not repeated with respect to FIG. 6.

The elements of the modular architectural garden assembly 46 include vertically oriented posts 14″, horizontally oriented beams 12″ and connectors 10 for connecting beams 12″ to posts 14″. The connectors 10″ are mounted on the top of posts 14″. Different connectors 10″ may be used to provide connections for joining adjacent ends of two or more beams 12″. In the preferred embodiment, each connector 10″ may connect up to four beams 12″. For orthogonal beam connections, connectors with orthogonal rigid flanges such as the connector 10″ shown in FIGS. 1 to 3 may be used to connect the beams. The connectors 10″ allow adjacent ends of at least two beams to be joined wherein the beams are oriented transversely relative to each other as illustrated in FIG. 6. For non-orthogonal beam connections, connectors 10′ with pivotable flanges 34′ as shown in FIGS. 4 and 5 may be used to connect the beams. The connectors 10″ with pivotable flanges 34′ allow adjacent ends of at least two beams to be joined wherein the beams are oriented to define non-orthogonal angles. The connectors 10″ with pivotable flanges 34′ provide advantages over prior art connectors as they allow flexibility in the design of the architectural garden buildings especially to create architectural garden buildings to fit irregular shaped gardens.

The elements of the modular architectural garden assembly can be combined to generate a variety of structures of different shapes and sizes. Additional decorative and/or structural elements such as panels, gates, trellis, beam ends, rails or brackets may be added to the assembly.

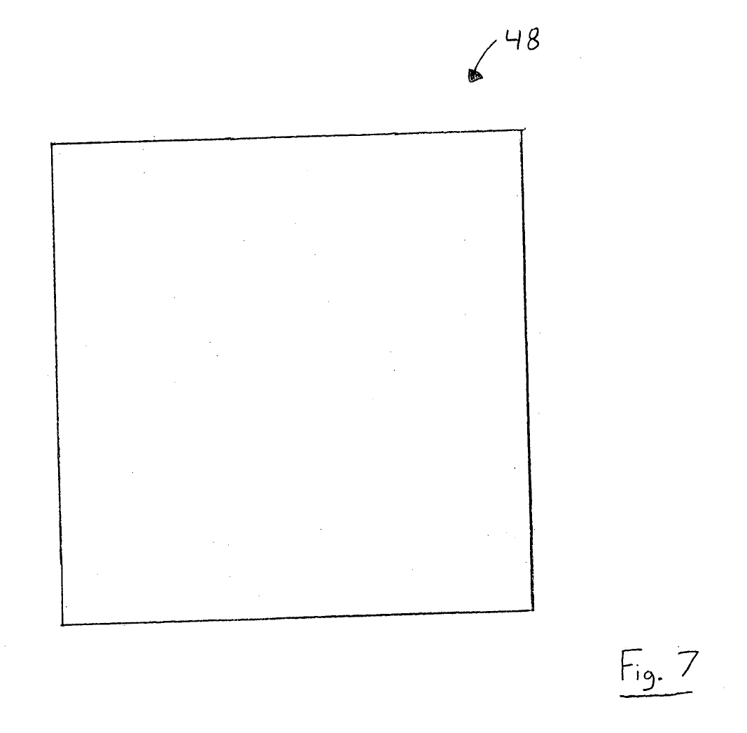

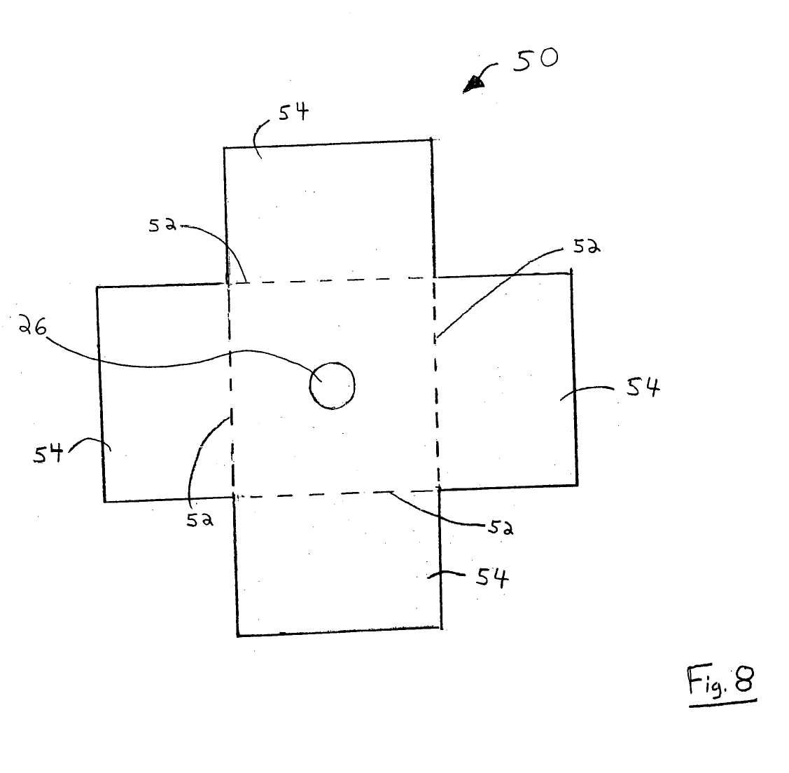

Referring to FIGS. 7 to 12, a method of constructing the connector 10 of FIG. 1 is described with reference to these figures. Specifically, referring to FIG. 7, a plate 48 is illustrated in a plan view. This plate 48 is used to make the post-receiving member 16 of the connector 10 of FIG. 1.

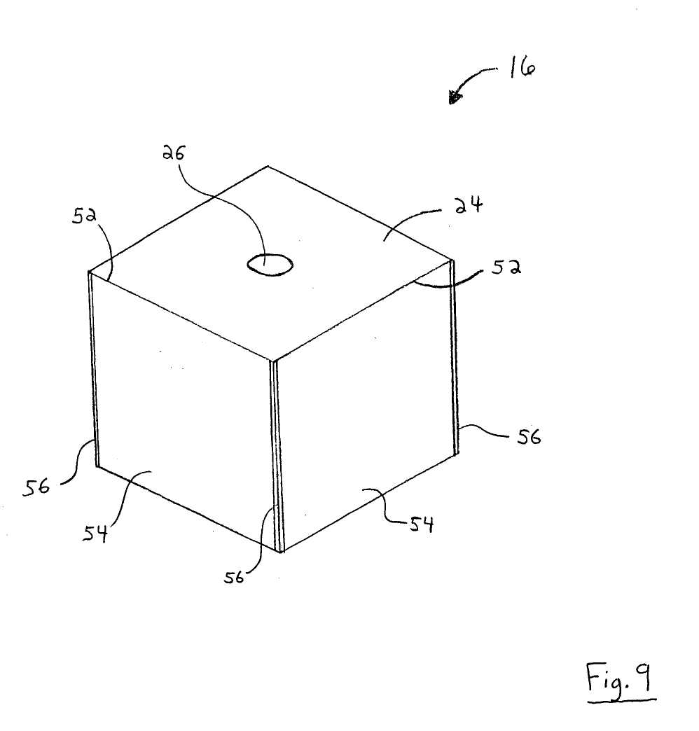

Referring to FIG. 8, a cross-shaped plate 50 with aperture 26 cut out is illustrated. The cross-shaped plate 50 is obtained from plate 48 by removing a square portion from each of the corners of plate 48, and by cutting out the central aperture 26. Also shown on the cross-shaped plate 50 are dashed bend lines 52 about which four outlying-pieces 54 can be bent.

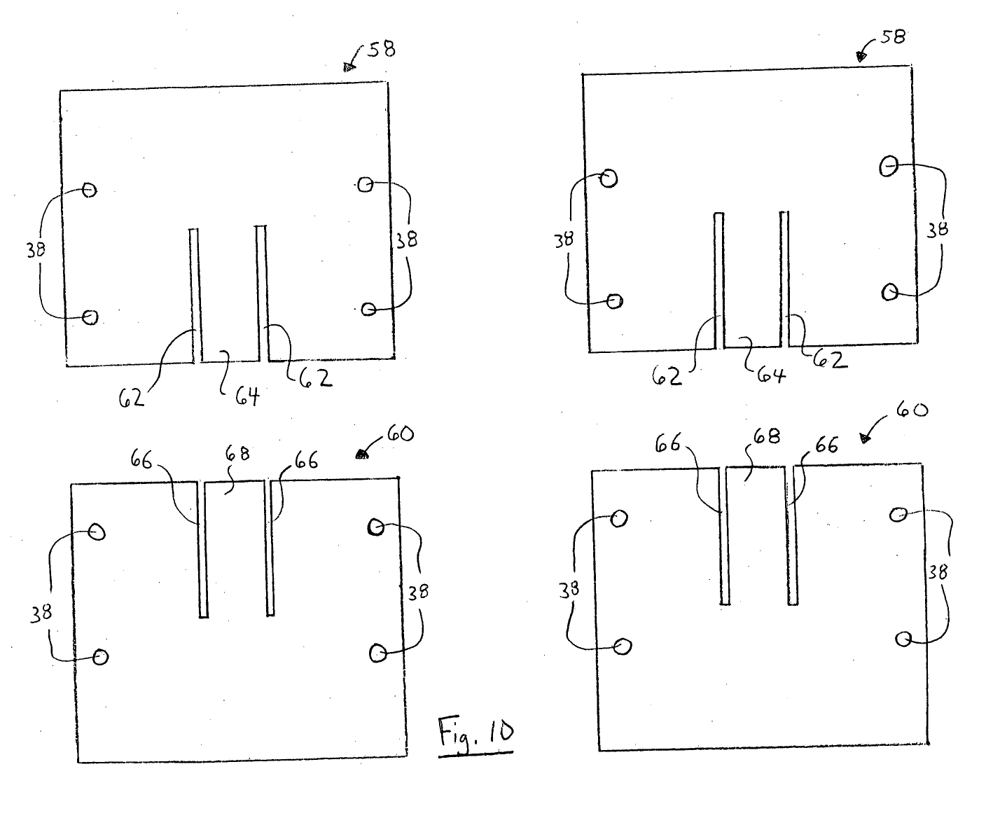

Referring to FIG. 9, the post-receiving member 16 is illustrated. This post-receiving member 16 is obtained from cross-shaped plate 50 by bending the four outlying-pieces 54 about their respective bend lines 52 to ninety degrees relative to their initial orientation. The four bent outlying-pieces 54 can then be welded together at their edges 56 to increase the rigidity of the post-receiving member 16. As shown, the interior sides of the four bent outlying-pieces 54 will then provide the elongate interior wall 22 of the post-receiving member 16, while a central square portion between the four bent outlying-pieces 54 will provide the closed end 24 of the post-receiving member 16.

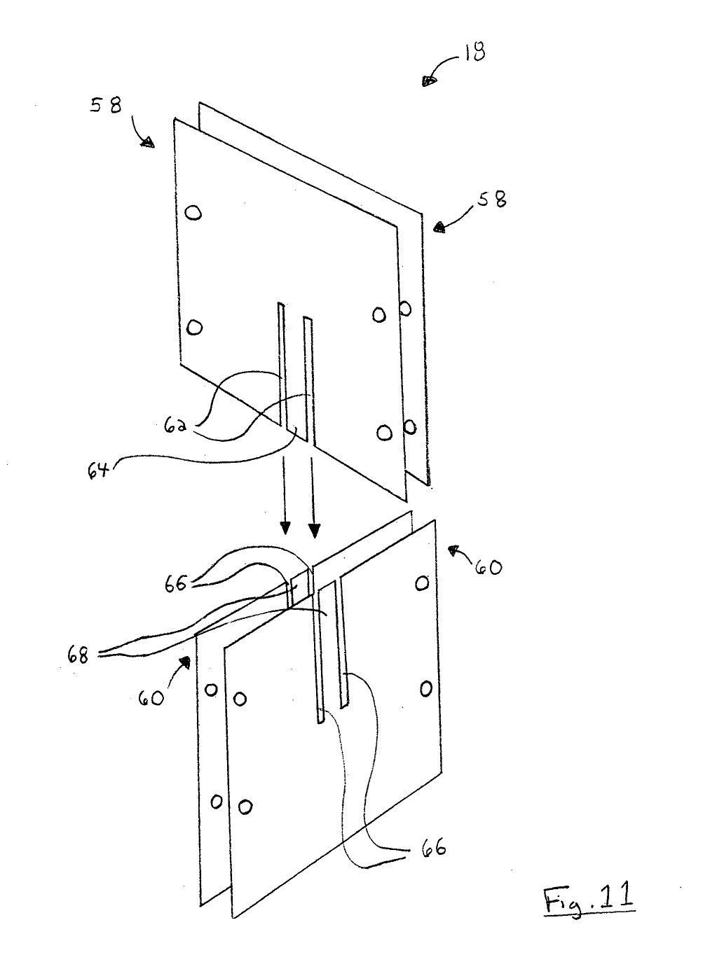

Components used in accordance with a method of manufacturing the beam-securing number 18 of FIG. 1 are illustrated in FIGS. 10 to 12. Referring to FIG. 10, there is illustrated a first pair of plates 58 and a second pair of plates 60. As shown in FIG. 10, each plate in the first pair of plates 58 includes two bottom elongate slits 62, which are separated by an inter-slit portion 64. Similarly, each plate in the second pair of plates 60 includes two top elongate slits 66, which are similarly separated by an inter-slit portion 68. Typically, the first pair of plates 58 and the second pair of plates 60 will be identical, the only difference being that the second pair of plates 60 have been flipped over relative to the first pair of plates 58 such that the two bottom elongate slits 62 are oppositely oriented from the two top elongate slits 66.

Referring to FIG. 11, there is illustrated in a perspective view, how the first pair of plates 58 and second pair of plates 60 are mated together to provide the beam-securing member 18. Specifically, as shown in FIG. 11, the first pair of plates 58 are placed parallel to each other, separated by the width of the inter-slit portion 68 of the second pair of plates 60. Analogously, the second pair of plates 60 are oriented parallel to each other, separated by the width of the inter-slit portion 64 of each of the two plates 58. The slits 62 and 66 are then aligned, and inserted together, to mate the first two plates 58 with the second two plates 60 through their corresponding elongated slits to form the beam-securing member 18.

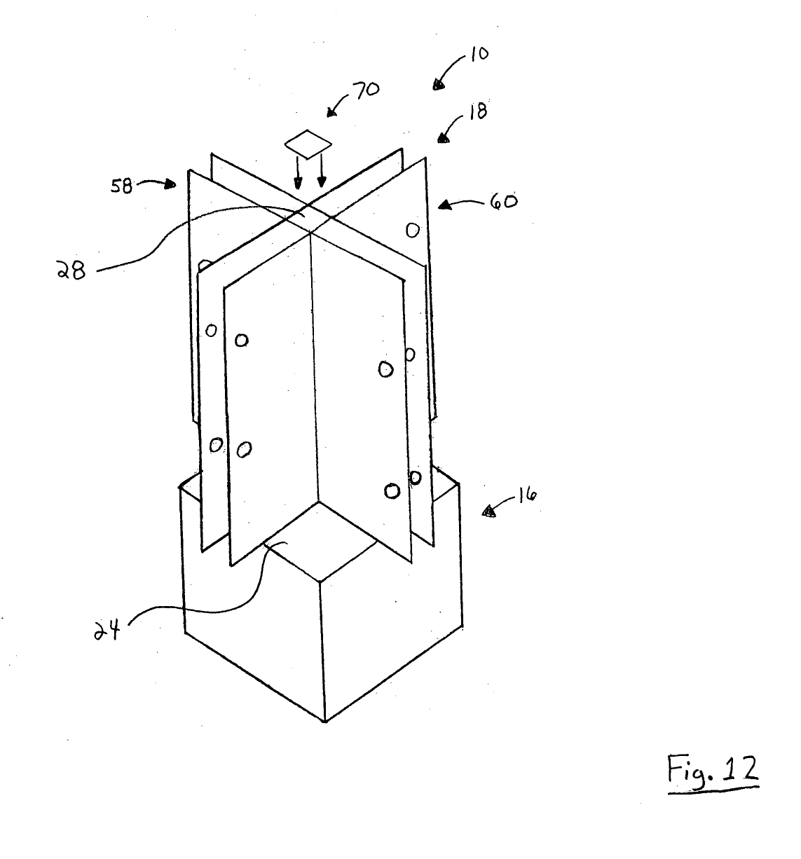

Referring to FIG. 12, the connector 10 is shown almost fully assembled. That is, as shown in FIG. 12, the almost fully assembled beam-securing member 18 comprises the rigid support member 28, which is made up of the inter-slit portions 64 and 68. The plates 58 and 60 are preferably welded together. As shown, cap 70 can then be welded to the top of rigid support member 28 to increase the rigidity of rigid support member 28, as well as to prevent the entry of water into rigid support member 28. The beam-securing member 18 may also be secured to the post-receiving member 16 by welding the adjoining portions of plates 58 and 60 to closed-end 24 of post-receiving member 16.

Other variations and modifications of the invention are possible. For example, while a preferred method of manufacturing the connector 10 of FIGS. 1 to 3 is described in connection with FIGS. 7 to 12, it will be appreciated by those of skill in the art that other manufacturing methods may be used. In addition, all of the flanges of the beam-securing member may be pivotable, instead of only some of these flanges being pivotable. All such modifications or variations are believed to be within the sphere and scope of the invention as defined by the claims appended hereto.

1. A connector for connecting a plurality of beams to a post, the connector comprising:
a post-receiving member for receiving the post, wherein the post-receiving member comprises an open end for receiving the post, an elongate interior wall for surrounding a portion of the post inserted into the post-receiving member, and a closed end for impeding further insertion of the post into the post-receiving member, wherein the elongate interior wall is dimensioned to impede substantial lateral movement of the post within the post-receiving member; and,
a beam-securing member for securing a plurality of beams, the beam-securing member being coupled to the post-receiving member.

2. The connector as defined in claim 1 wherein the beam-securing member is attached to the post-receiving member at the closed end thereof.

3. The connector as defined in claim 1 wherein the beam-securing member comprises a plurality of flanges for securing the plurality of beams.

4. The connector as defined in claim 3 wherein the beam-securing member comprises a rigid support member rigidly coupled to the post-receiving member, and the plurality of flanges comprises a plurality of rigid flanges, and the rigid support member is rigidly coupled to the post-receiving member by the plurality of rigid flanges.

5. The connector as defined in claim 3 wherein the beam-securing member comprises a rigid support member rigidly coupled to the post-receiving member, and the plurality of flanges comprises at least one pivotable flange for pivoting about a longitudinal axis of the post, wherein the at least one pivotable flange is coupled to the rigid support member by at least one pivotable attachment.

6. The connector as defined in claim 5 wherein
the post-receiving member comprises a flange-supporting surface for supporting the plurality of flanges;
the plurality of flanges extend away from the rigid support member over the flange-supporting surface; and,
the at least one pivotable flange is movable along the flange-supporting surface such that the flange-supporting surface is operable to support the at least one pivotable flange during pivoting of the pivotable flange about the longitudinal axis.

7. A modular architectural garden assembly comprising:
a plurality of posts;
a plurality of beams;
a plurality of connectors for connecting beams to posts wherein each connector in the plurality of connectors includes:
a post-receiving member for receiving the post, the post-receiving member having an open end for receiving the post and an elongate interior wall for surrounding a portion of the post inserted into the post-receiving member, and a closed end for impeding further insertion of the post into the post-receiving member, the elongate interior wall being dimensioned to impede substantial lateral movement of the post within the post-receiving member, and
a beam-securing member for securing a plurality of beams, the beam-securing member being coupled to the post-receiving member.

8. The modular architectural garden assembly as defined in claim 7 wherein the closed end of the post-receiving member is operable to receive the post-receiving member and the beam-securing member and the attached beam at a top of the post when a longitudinal axis of the post is substantially vertically oriented.
